(19) United States
(12) Patent Application Publication
(10) Pub. No.: US 2017/0057322 A1
(43) Pub. Date: Mar. 2, 2017

(54) METHOD OF CONTROLLING A CABIN TEMPERATURE OF A HYBRID OR A START-STOP EQUIPPED VEHICLE

(71) Applicant: FORD GLOBAL TECHNOLOGIES, LLC, Dearborn, MI (US)

(72) Inventors: Christopher Michael Kava, Taylor, MI (US); Mark Anthony Rockwell, Wyandotte, MI (US); Justin Reuel Badger, Plymouth, MI (US)

(21) Appl. No.: 14/839,146

(22) Filed: Aug. 28, 2015

(51) Int. Cl. B60H 1/00

(52) U.S. Cl. CPC B60H 1/00778; B60H 1/00742; B60H 1/00878; B60H 1/00985

(57) ABSTRACT

A method of controlling a cabin temperature of a hybrid or a start-stop equipped vehicle when idling is provided. The method includes the steps of: (a) monitoring a state of the vehicle transmission; (b) sensing a temperature within the cabin of the vehicle; and (c) overriding an initial setting of a climate control system of the vehicle after the state of the vehicle transmission has been in park for a predetermined period of time and the sensed cabin temperature is within a predetermined temperature range. The initial setting of the climate control system may be adjusted to maintain the cabin temperature within the predetermined temperature range. A vehicle operator may be informed of the override via wireless communication or a visual indication.

### TECHNICAL FIELD

This document relates generally to vehicle efficiency, and more specifically to a method of controlling cabin temperature of vehicles when idling or parked.

### BACKGROUND

It is well known that hybrid or start-stop equipped vehicles are fuel efficient in part due to their ability to turn the engine off when idling. This is one reason that hybrid or start-stop vehicles are commonly utilized within commercial vehicle fleets. Fleet vehicles, such as taxi cabs, law enforcement and emergency service vehicles, and delivery vehicles, often spend more time in extended idle conditions than other types of vehicles. Of course, this is not always the case, but generally speaking fleet vehicles idle more due to the nature of their usage (e.g., taxi cabs are stationary while waiting on fares, police vehicles are often parked while on duty, and delivery vehicles are stationary when loading and unloading cargo).

As is well known, when a hybrid or a start-stop equipped vehicle stops, the engine typically turns off until the vehicle operator demands, through action, that the engine restart. This is the case, for example, at traffic signals, railroad crossings, and while waiting in lines. One inhibitor to the engine being turned off in these and other scenarios is the utilization of the vehicle's climate control system. When a vehicle's climate control system is in an “ON” state, the engine will not change to an “OFF” state when the vehicle stops thereby missing an opportunity to increase efficiency.

Even more, it is often the case that an idling vehicle is unoccupied and its climate control system is set to a very aggressive level. For example, when a vehicle is initially started on a cold morning, the climate control system may be set to a maximum heat and/or maximum defrost setting in order to warm the vehicle and clear the windshield prior to the vehicle operator getting in the car. In such a scenario, the climate control system, and necessarily the engine, may run for several minutes before the vehicle operator returns and adjusts the climate control system to a more moderate setting. The same is the case in warm to hot weather when the climate control system may be set to a maximum cooling setting for a significant period of time before the vehicle operator enters or returns to the car. In both of these scenarios, overriding an initial setting of the climate control system could result in increased engine “OFF” time thereby providing an increase in fuel efficiency, increased reductions in vehicle emissions and noise, vibrations, and harshness (NVH), and more passenger comfort than if the cabin temperature reflected the aggressive climate control system settings initially utilized,

In addition, there may be times when the climate control system is not in an “ON” state when the vehicle is idling, or the system may be set such that extreme temperatures within the vehicle cabin are able to occur (e.g., heater on in hot weather) due to outside effects (e.g., solar or high or low ambient temperatures) on the vehicle. In these scenarios, the initial settings of the climate control system may be overridden and adjusted in order to ensure a more satisfying passenger experience in general, or to prevent over or under heating conditions within the vehicle cabin.

Accordingly, a need exists for a more fuel efficient way to control a cabin temperature of hybrid and start-stop equipped vehicles. Ideally, this can be accomplished by monitoring conditions, including in the vehicle cabin, and adjusting the climate control system to moderate or predetermined settings. In one scenario, the presence or absence of a passenger in the vehicle could affect the adjustments. Even more, the vehicle owner could be alerted when the climate control system is adjusted. In this manner, the adjustment could be controlled by the vehicle operator if desired. Advantageously, controlling the cabin temperature in such a manner would result in improved fuel efficiency, decreased vehicle emissions and NVH, more passenger comfort, better vehicle operator satisfaction resulting from increased engine off time, and improved safety through the control of cabin temperatures.

### SUMMARY OF THE INVENTION

In accordance with the purposes and benefits described herein, a method is provided of controlling a cabin temperature of a hybrid or a start-stop equipped vehicle when idling. The method may be broadly described as comprising the steps of: monitoring a state of the vehicle transmission; sensing a temperature within the cabin of the vehicle; and overriding an initial setting of a climate control system of the vehicle after the state of the vehicle transmission has been in park for a predetermined period of time and the sensed cabin temperature is within a predetermined temperature range.

In one possible embodiment, the step of overriding the setting of the climate control system further includes the step of adjusting the initial setting of the climate control system to maintain the cabin temperature within the predetermined temperature range.

In another possible embodiment, the method further includes the step of informing a vehicle operator that the initial climate control setting was overridden. In yet another possible embodiment, the step of informing a vehicle operator that the initial climate control setting was overridden includes the step of sending a wireless communication. In still another possible embodiment, the step of informing a vehicle operator that the initial climate control setting was overridden includes the step of initiating a visual indication.

In one additional possible embodiment, the informing step includes the step of alerting the vehicle operator that the adjusted climate control setting may be returned to the initial climate control setting by the vehicle operator.

In another possible embodiment, the method further includes the step of receiving an input from the vehicle operate to return the adjusted climate control setting to the initial climate control setting.

In yet another possible embodiment, the method further includes the step of sensing a presence of a passenger within the vehicle, and overriding the initial climate control setting of the vehicle only if no passenger is present within the vehicle.

In still another possible embodiment, the method further includes the step of informing a vehicle operator that the initial climate control setting was overridden.

In an additional possible embodiment, the method further includes the steps of monitoring a state of at least one of a plurality of doors and a plurality of openable windows, and informing a vehicle operator that one or more of said at least one of said plurality of doors and said plurality of openable windows is in an open state.

In yet one other possible embodiment, a method of controlling a cabin temperature of a hybrid or a start-stop equipped vehicle when the vehicle is parked and idling includes the steps of sensing a temperature within the cabin of the vehicle, sensing a presence of a passenger within the vehicle, and adjusting a setting of a climate control system of the vehicle if the sensed cabin temperature is outside of a predetermined temperature range.

In another possible embodiment, the step of adjusting the setting of the climate control system of the vehicle includes the step of turning the climate control system from an off state to an on state.

In yet another possible embodiment, the method further includes the step of informing a vehicle operator that the setting of the climate control system was adjusted. In another, the step of informing a vehicle operator that the setting of the climate control system was adjusted includes the step of sending a wireless communication.

In another possible embodiment, a circuit for controlling a cabin temperature of a hybrid or a start-stop equipped vehicle when idling may be broadly described as comprising a temperature sensor for sensing a cabin temperature of the vehicle, a control module for receiving a first signal indicative of the cabin temperature of the vehicle and a second signal indicative of a state of a transmission of the vehicle, and a climate control system, responsive to said control module, for overriding a setting of said climate control module if the sensed cabin temperature is within a predetermined range and the state of said transmission has been in a park state for at least a predetermined period of time.

In still another possible embodiment, the setting of said climate control system is adjusted to maintain the cabin temperature within the predetermined temperature range.

In yet another possible embodiment, the circuit further includes an indicator for informing a vehicle operator that the setting of said climate control module was overridden.

In another possible embodiment, the circuit further includes a transmitter for sending a wireless communication informing a vehicle operator that the setting of said climate control module was overridden.

In still yet another possible embodiment, the circuit further includes a presence sensor for sensing a presence of a passenger within the vehicle, and wherein said control module only overrides the setting of said climate control system if no passenger is sensed.

In other possible embodiments, the circuits for controlling a cabin temperature of a hybrid or a start-stop equipped vehicle described above are incorporated into a vehicle.

In the following description, there are shown and described several embodiments of a method of controlling a cabin temperature of a hybrid or a start-stop equipped vehicle when idling and a related circuit. As it should be realized, the methods and circuits are capable of other, different embodiments and their several details are capable of modification in various, obvious aspects all without departing from the methods and assemblies as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the vehicle, circuits, and method and together with the description serve to explain certain principles thereof. In the drawing figures:

FIG. 1 is a is a block diagram of an exemplary circuit including a climate control module for controlling a cabin temperature of a hybrid or a start-stop equipped vehicle when idling; and

FIG. 2 is a flow chart schematic for controlling a cabin temperature of a hybrid or a start-stop equipped vehicle when idling.

Reference will now be made in detail to the present preferred embodiments of the method of controlling a cabin temperature of a hybrid or a start-stop equipped vehicle when idling and related circuits, examples of which are illustrated in the accompanying drawing figures, wherein like numerals are used to represent like elements.

### DETAILED DESCRIPTION

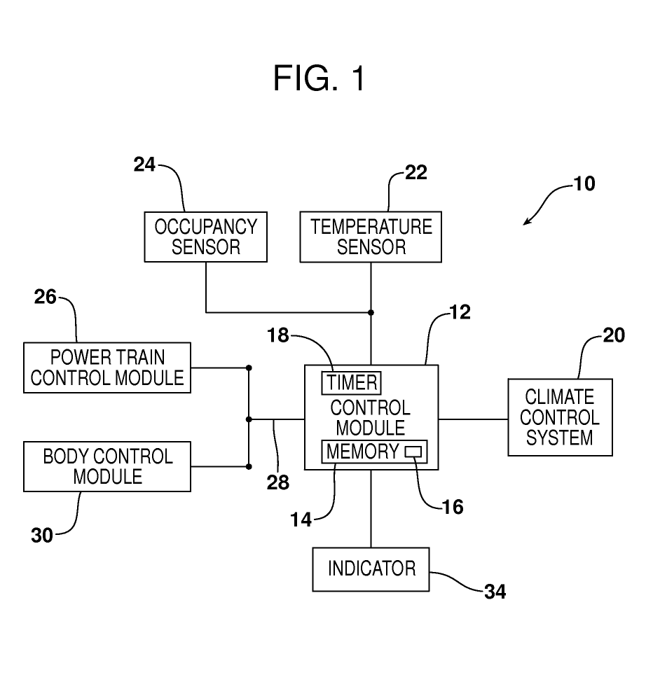

Reference is now made to FIG. 1 illustrating a schematic diagram of an exemplary control circuit 10 including a control module 12 for controlling a cabin temperature (T_{C}) of a hybrid or a start-stop equipped vehicle when idling. As shown, the described embodiment includes the control module 12 which has a memory 14 that stores a cabin temperature control program 16 run by the control module, and an internal timer 18. The timer 18 is utilized to determine elapsed times, among other tasks, as will be described in more detail below. Such elapsed times, predetermined periods of time, and/or temperature set points and ranges described herein are configurable and may be changed during the manufacturing process, or in possible alternate embodiments by the vehicle owner.

In the described control circuit 10, the control module 12, which is a climate control module, continuously monitors and receives inputs concerning various conditions associated with the vehicle. The inputs may be received directly from a sensor (e.g., a temperature sensor, a seat belt status sensor indicating whether the seat belt is engaged, a load sensor indicating a passenger in a seat) or the like, or from other control modules within the vehicle via a controller area network (CAN) bus 28. Dependent upon those inputs, the control module 12 may initiate certain actions including, for example, overriding or adjusting a setting of a climate control system 20. In the described embodiment, the climate control system 20 includes an air conditioning system and a heating system. Other embodiments may include one or more climate related systems or subsystems.

Depending on the input conditions, the control module 12, in response to outputs of the cabin temperature control program 16, may determine to override an initial or current setting of the climate control system 20. The override or adjustment to the settings of the climate control system 20 includes raising or lowering a cabin temperature setting or temperature range setting, or turning the climate control system to an “ON” state or an “OFF” state. Finer adjustments to the climate control system 20 may also be made in alternate embodiments, such as, lowering a blower fan setting associated with a defrost mode. In the described embodiment, the override or adjustment may involve more than one setting of the climate control system 20.

In the described embodiment, the control module 12 overrides an initial setting of the climate control system 20 of an idling vehicle after a state of a vehicle transmission has been in “PARK” for a predetermined period of time (e.g., 15 minutes) and the sensed cabin temperature (T_{C}) is within a predetermined temperature range (e.g., between 65 and 75 degrees Fahrenheit). In such a scenario, the initial setting is overridden and the climate control system 20 is adjusted to automatically maintain the cabin temperature (T_{C}) at or near 72 degrees Fahrenheit. In this manner, the temperature within the vehicle is maintained at a comfortable setting rather than a more extreme setting (e.g., maximum AC).

Maintaining the temperature within the vehicle at the comfortable or more moderate setting allows the vehicle to turn the engine to an “OFF” state, at least periodically, which improves fuel efficiency. In alternate embodiments, the adjustment may be to turn the climate control system to an “OFF” state or to maintain the temperature within the cabin of the vehicle within a range of temperatures. As suggested above, these predetermined temperature set points and ranges are configurable and may be changed during the manufacturing process, or in possible alternate embodiments by the vehicle owner.

Further actions initiated by the control module 12 may include alerting or informing a vehicle operator, a fleet manager, an emergency responder, or others to the fact that the initial climate control setting was overridden. The alert may include a message indicating that the setting was overridden, a message including specific information concerning an adjustment made to the climate control system 20, or, more simply, an indication that the adjustment was made.

In the described embodiment, the control circuit 10 includes a temperature sensor 22 for sensing a temperature (T_{C}) within the cabin or interior of the vehicle. The sensor 22 may be positioned anywhere within the vehicle cabin and may include multiple temperature sensors positioned throughout the cabin. An output of the temperature sensor 22 indicative of the cabin temperature (T_{C}) is received by the control module 12 and used in determining whether to override the initial setting of the climate control system 20. In an alternate embodiment, the output of the temperature sensor may be received by the control module 12 via a second control module (not shown) within the vehicle via the CAN bus.

Additional outputs are likewise received by the control module 12 from sensors/control modules within the vehicle either directly or via the CAN bus 28. For instance, an occupancy sensor 24 generates an output indicating the presence of an occupant within one or more seats of the vehicle. The occupancy sensor 24 is a load sensor positioned in the driver's seat of the vehicle in the described embodiment. An output of the occupancy sensor 24 indicative of the presence of an occupant within the driver seat of the vehicle is received by the control module 12 and used in determining whether to override the initial setting of the climate control system 20. In alternate embodiments, the occupancy sensor may include a plurality of sensors associated with each seat of the vehicle and/or one or more motion sensors positioned within the cabin of the vehicle.

A power train control module 26 monitors a state of the vehicle transmission and provides an output indicative of a gear in which the transmission currently resides (e.g., park, drive, neutral, etc.) to the control module 12 via the CAN bus 28. The power train control module 26 also monitors a state of the engine and provides an output indicative of the “ON” or “OFF” state of the engine to the control module 12 via the CAN bus 28. Similarly, a body control module 30 monitors a state of the openable windows and/or doors in the described embodiment and provides an output indicative of an “OPEN” or “CLOSED” state of each openable window and door to the control module 12 via the CAN bus 28. Each of these inputs may be utilized in determining whether to override an initial setting of the climate control system 20.

In other embodiments, the cabin temperature or presence of a vehicle operator or other passenger could be obtained by the control module 12 periodically or in response to certain events rather than continuously. For example, the temperature could be obtained a predetermined time after the vehicle transmission was placed in park or only if the presence of a passenger is not detected.

As indicated generally above, the control module 12 may alert or inform the vehicle operator, or others, to the fact that the initial climate control setting was overridden. In the described embodiment, the control circuit 10 includes an indicator 34 in the form of a display screen. The display screen is mounted in the instrument panel of the vehicle in the described embodiment but could also be a heads-up display displaying the alert on the windshield.

The display screen 34 displays the alert in the form of a message. As will be described in more detail below, the message includes information indicating that the setting was overridden, specific information concerning an adjustment made to the climate control system 20, and/or, more simply, an indication that the adjustment was made. In alternate embodiments, the message could include any information or the vehicle operator could prescribe what information is provided within such an alert message and when or under what circumstances such messages are to be provided.

Even more, in a simplistic system, the indicator, such as a light on the instrument display panel, could simply provide a visual indication that an adjustment has been made. In a more robust system, the indicator could include a transmitter for sending a wireless communication or the like informing a remote vehicle operator that the setting of the climate control module was overridden. The wireless communication could be any type of wireless communication including, for example, a text message indicating an adjustment was made or that a need for an adjustment exists.

One message provided to the vehicle operator includes an alert or indication that the actions taken automatically to override the initial climate control setting may be disabled by the vehicle operator. In such a scenario, the vehicle operator can disable the override thereby returning the climate control system 20 to the initial climate control setting. Disablement may occur at any time. For example, the vehicle operator may selectively disable the cabin temperature control program 16 utilizing the display screen 34 and input devices associated therewith (e.g., a push button or selector knob) as is known. Even more, the vehicle operator could override the cabin temperature control program 16 after the initial climate control setting has been adjusted in response to an alert message or otherwise. In this instance, the vehicle operator could disable the cabin temperature control program 16 via a wireless communication (e.g., a return text message or a signal from a key fob).

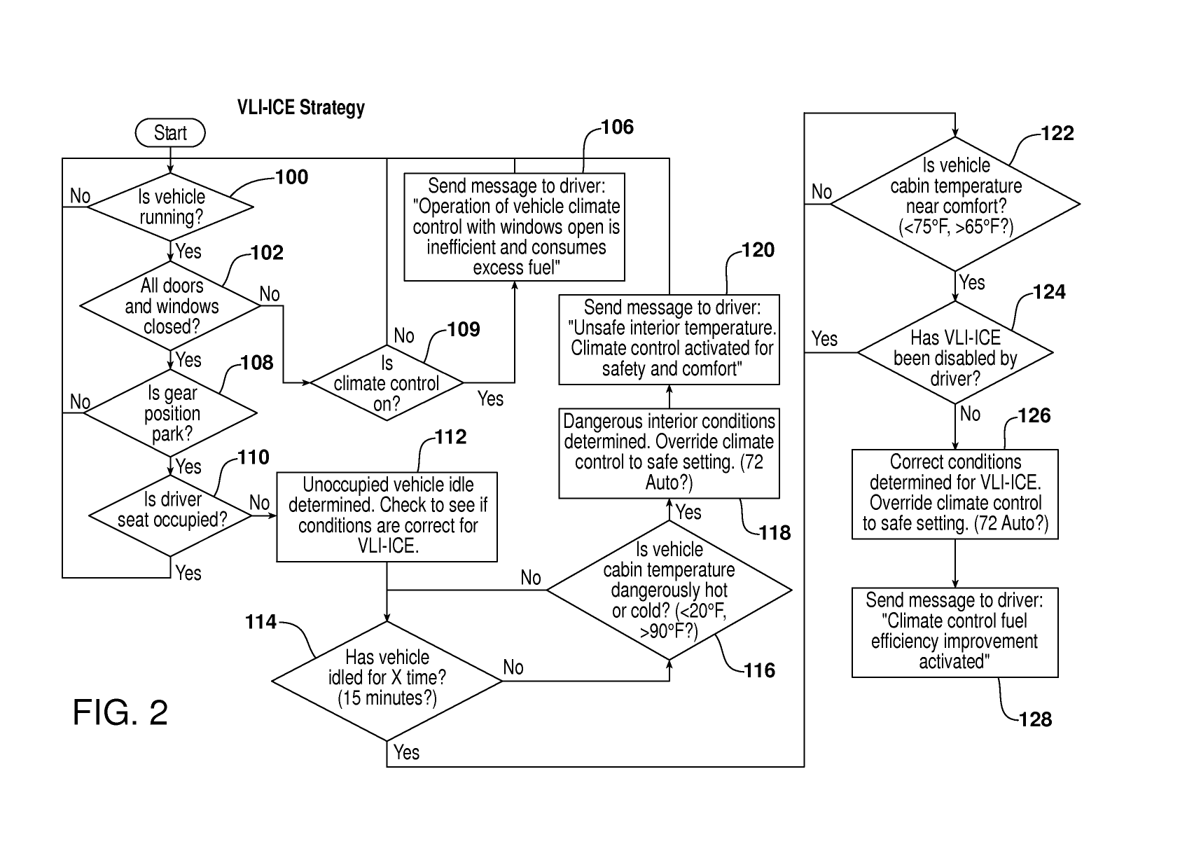

The steps utilized in the described embodiment will now be described with reference to FIG. 2. FIG. 2 is a flowchart of operational control of the control circuit 20 of the vehicle according to the described embodiment. The processing sequence related to operational control according to the described embodiment is executed by a processor (not shown) of control module 12 as a cabin temperature control program 16 stored in memory 14.

Upon initiation of the sequence, the processor within the control module 12 determines an “ON” or “OFF” state of the engine at Step 100. This determination is made based on input from the powertrain control module 26. If the state of the engine is “OFF,” then the processor continues to monitor the state of the engine at Step 100 until a change is determined. Once the state of the engine changes to “ON,” then the processor determines an “OPEN”/“CLOSED” state of the windows at Step 102 based on input from the body control module 28. If the state of one or more the windows is “OPEN,” then the processor determines a state of the climate control system 20 at Step 104. If the climate control system 20 is in an “OFF” state, then the sequence returns to Step 100.

If the climate control system 20 is in an “ON” state at Step 104, then an alert is provided to a vehicle operator at Step 106 informing the vehicle operator that operating the climate control system 20 with one or more windows open is inefficient. In the described embodiment, the alert is in the form of a message (e.g., “Operation of vehicle climate control with windows open is inefficient and consumes excess fuel.”) and is provided to the vehicle operator via an indicator 34. As described above, the indicator may take many forms and in the described embodiment is a display screen sufficient to display the message and inform the vehicle operator of the circumstances. After providing the message to the vehicle operator, the sequence restarts at Step 100.

Once the state of the windows is “CLOSED” at Step 102, then the processor determines a state of the transmission at Step 108. This determination is made based on input from the powertrain control module 26. If the transmission is in a state other than “PARK,” then the sequence restarts at Step 100. If the transmission is in “PARK,” then the processor determines an occupancy state of the vehicle at Step 110 based on input from an occupancy sensor 24. In the described embodiment, the occupancy of only the driver's seat is determined but in other embodiments any occupancy within the interior or cabin of the vehicle can be determined (e.g., a sleeping passenger or a pet). If the occupancy sensor senses a presence in the vehicle at Step 110, then the initial climate control setting will not be overridden and the sequence restarts at Step 100. If the occupancy sensor 24 determines that the vehicle is unoccupied, then an unoccupied vehicle idle condition is declared as noted at Step 112 and the timer 18 is initiated.

At Step 114, the processor determines whether the vehicle has been parked for a predetermined period of time. In the described embodiment, the predetermined period of time is 15 minutes. In alternate embodiments, the predetermined period of time could be longer or shorter. In one alternate embodiment, if the unoccupied vehicle idle condition is declared, then further processing could begin immediately without any time delay, i.e., the predetermined period of time is zero. Of course, as with the predetermined temperature set points and ranges, the predetermined period of time is configurable and may be changed during the manufacturing process, or in possible alternate embodiments by the vehicle owner.

If the vehicle has not been parked and idling for more than fifteen minutes, then the processor determines whether the sensed cabin temperature (T_{C}) is within a predetermined temperature range at Step 116. If the sensed cabin temperature (T_{C}) is within the predetermined temperature range, then the sequence returns to Step 114 to determine whether the vehicle has been parked and idling for the predetermined period of time. In the described embodiment, the predetermined temperature range is between twenty and ninety degrees Fahrenheit. Of course, the predetermined temperature range could be any range selected by the manufacturer or vehicle operator.

If the processor determines that the sensed cabin temperature is outside of the predetermined temperature range (e.g., above ninety degrees Fahrenheit) at Step 116, then the climate control module 12 overrides an initial setting of the climate control system 20 at Step 118 and informs the vehicle operator that the initial setting of the climate control system was adjusted at Step 120.

In the described embodiment, the initial setting of the climate control system 20 is overridden at Step 118 and adjusted in order to maintain the cabin temperature at or near a specific temperature (e.g., seventy-two degrees Fahrenheit). In other instances, the climate control system could be overridden such that the initial setting is adjusted in order to maintain the cabin temperature within a predetermined temperature range. It should also be noted that the initial setting could include the climate control system being in an “OFF” state. In such a circumstance, the adjustment of the initial setting would necessarily include turning the climate control system from the “OFF” state to an “ON” state, and then further adjusting the setting, if required, to ensure a specific temperature or temperature range of cabin temperature as described above.

Further, an alert is provided to the vehicle operator at Step 120. In the described embodiment, the alert is in the form of a message (e.g., “Unsafe interior temperature. Climate control activated for safety and comfort.”) provided to the vehicle operator via an indicator 34. As described above, the indicator 34 may be any type of display sufficient to display the message and provide information to the vehicle operator. After providing the message to the vehicle operator, the sequence restarts at Step 100.

If the vehicle has been parked and idling for more than fifteen minutes, on the other hand, then the processor determines whether the sensed cabin temperature is within a more moderate predetermined temperature range at Step 122. If the sensed cabin temperature (T) is not within the predetermined temperature range, then the sequence loops back to Step 122 to essentially monitor the temperature relative the predetermined temperature range. At this point in the sequence, the predetermined temperature range is generally concerned with comfort rather than safety. Accordingly, in the described embodiment, the predetermined temperature range utilized in Step 122 is between sixty-five and seventy-five degrees Fahrenheit. Of course other temperature ranges could be utilized.

If the processor determines that the sensed cabin temperature (T_{C}) is within the predetermined temperature range (e.g., seventy-two degrees Fahrenheit) at Step 122, then the processor determines whether the vehicle operator has provided an input to disable overriding of the initial climate control setting at Step 124. In other words, the processor determines whether the vehicle operator disabled the climate control program 16. If the vehicle operator has provided an input essentially overriding the adjustments to the climate control setting, then the sequence returns to Step 122 and monitors the cabin temperature until the vehicle operator re-enabling the climate control program 16.

In the event, the vehicle operator has not provided an input to disable overriding of the initial climate control setting at Step 124 (or has provided an input overriding an original input to do so), then the conditions have been met and the climate control module 12 overrides an initial setting of the climate control system 20 at Step 126 and informs the vehicle operator that the initial setting of the climate control system was adjusted at Step 128.

In this instance, the climate control system 20 would be overridden at Step 126 such that the initial setting is adjusted in order to maintain the cabin temperature within the predetermined temperature range. In the described embodiment, however, the initial setting is adjusted in order to maintain the cabin temperature at or near a specific temperature (e.g., seventy-two degrees Fahrenheit). It should also be noted that the initial setting could include the climate control system being in an “OFF” state. In such a circumstance, the adjustment of the initial setting would necessarily include turning the climate control system from the “OFF” state to an “ON” state, and then further adjusting the setting to ensure a specific temperature or temperature range of cabin temperature as described above.

Further, an alert is provided to a vehicle operator at Step 128. In the described embodiment, the alert is in the form of a message (e.g., “Climate control fuel efficiency improvement activated.”) and is provided to the vehicle operator via an indicator 34. As described above in the described embodiment, the indicator may be any type of display sufficient to display the message and provide information to the vehicle operator. After providing the message to the vehicle operator, the sequence ends until restarted by additional actions of the vehicle operator. For example, turning the vehicle to an “OFF” state and then turning the vehicle to an “ON” state.

In summary, numerous benefits result from the method of controlling a cabin temperature of a hybrid or start-stop equipped vehicle while stopped or idling as illustrated in this document. The method is capable of controlling the cabin temperature such that an improved fuel efficiency is realized. Even more, decreased vehicle emissions and NVH, more passenger comfort, better vehicle operator satisfaction resulting from increased engine off time, and improved safety are provided through the control of cabin temperatures.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A method of controlling a cabin temperature of a hybrid or a start-stop equipped vehicle when idling, comprising the steps of:
monitoring a state of the vehicle transmission;
sensing a temperature within the cabin of the vehicle; and
overriding an initial setting of a climate control system of the vehicle after the state of the vehicle transmission has been in park for a predetermined period of time and the sensed cabin temperature is within a predetermined temperature range.

2. The method of controlling a cabin temperature of a hybrid or a start-stop equipped vehicle when idling of claim 1, wherein the step of overriding the setting of the climate control system further includes the step of adjusting the initial setting of the climate control system to maintain the cabin temperature within the predetermined temperature range.

3. The method of controlling a cabin temperature of a hybrid or a start-stop equipped vehicle when idling of claim 2, further comprising the step of informing a vehicle operator that the initial climate control setting was overridden.

4. The method of controlling a cabin temperature of a hybrid or a start-stop equipped vehicle when idling of claim 3, wherein the step of informing a vehicle operator that the initial climate control setting was overridden includes the step of sending a wireless communication.

5. The method of controlling a cabin temperature of a hybrid or a start-stop equipped vehicle when idling of claim 3, wherein the step of informing a vehicle operator that the initial climate control setting was overridden includes the step of initiating a visual indication.

6. The method of controlling a cabin temperature of a hybrid or a start-stop equipped vehicle when idling of claim 3, wherein the informing step includes the step of alerting the vehicle operator that the adjusted climate control setting may be returned to the initial climate control setting by the vehicle operator.

7. The method of controlling a cabin temperature of a hybrid or a start-stop equipped vehicle when idling of claim 6, further comprising the step of receiving an input from the vehicle operate to return the adjusted climate control setting to the initial climate control setting.

8. The method of controlling a cabin temperature of a hybrid or a start-stop equipped vehicle when idling of claim 1, further comprising the step of sensing a presence of a passenger within the vehicle, and overriding the initial climate control setting of the vehicle only if no passenger is present within the vehicle.

9. The method of controlling a cabin temperature of a hybrid or a start-stop equipped vehicle when idling of claim 8, further comprising the step of informing a vehicle operator that the initial climate control setting was overridden.

10. The method of controlling a cabin temperature of a hybrid or a start-stop equipped vehicle when idling of claim 1, further comprising the steps of monitoring a state of at least one of a plurality of doors and a plurality of openable windows, and informing a vehicle operator that one or more of said at least one of said plurality of doors and said plurality of openable windows is in an open state.

11. A method of controlling a cabin temperature of a hybrid or a start-stop equipped vehicle when the vehicle is parked and idling, comprising the steps of:
sensing a temperature within the cabin of the vehicle;
sensing a presence of a passenger within the vehicle; and
adjusting a setting of a climate control system of the vehicle if the sensed cabin temperature is outside of a predetermined temperature range.

12. The method of controlling a cabin temperature of a hybrid or a start-stop equipped vehicle when the vehicle parked and idling of claim 11, wherein the step of adjusting the setting of the climate control system of the vehicle includes the step of turning the climate control system from an off state to an on state.

13. The method of controlling a cabin temperature of a hybrid or a start-stop equipped vehicle when the vehicle parked and idling of claim 11, further comprising the step of informing a vehicle operator that the setting of the climate control system was adjusted.

14. The method of controlling a cabin temperature of a hybrid or a start-stop equipped vehicle when the vehicle parked and idling of claim 11, wherein the step of informing a vehicle operator that the setting of the climate control system was adjusted includes the step of sending a wireless communication.

15. A circuit for controlling a cabin temperature of a hybrid or a start-stop equipped vehicle when idling comprising:
a temperature sensor for sensing a cabin temperature of the vehicle;
a control module for receiving a first signal indicative of the cabin temperature of the vehicle and a second signal indicative of a state of a transmission of the vehicle; and
a climate control system, responsive to said control module, for overriding a setting of said climate control module if the sensed cabin temperature is within a predetermined range and the state of said transmission has been in a park state for at least a predetermined period of time.

16. The circuit for controlling a cabin temperature of a hybrid or a start-stop equipped vehicle when idling of claim 15, wherein the setting of said climate control system is adjusted to maintain the cabin temperature within the predetermined temperature range.

17. The circuit for controlling a cabin temperature of a hybrid or a start-stop equipped vehicle when idling of claim 15, further comprising an indicator for informing a vehicle operator that the setting of said climate control module was overridden.

18. The circuit for controlling a cabin temperature of a hybrid or a start-stop equipped vehicle when idling of claim 15, further comprising a transmitter for sending a wireless communication informing a vehicle operator that the setting of said climate control module was overridden.

19. The circuit for controlling a cabin temperature of a hybrid or a start-stop equipped vehicle when idling of claim 15, further comprising a presence sensor for sensing a presence of a passenger within the vehicle, and wherein said control module only overrides the setting of said climate control system if no passenger is sensed.

20. A vehicle incorporating the circuit for controlling a cabin temperature of a hybrid or a start-stop equipped vehicle when idling of claim 15.
